(19) United States
(12) Patent Application Publication
(10) Pub. No.: US 2008/0230946 A1
(43) Pub. Date: Sep. 25, 2008

(54) SOLUTION CASTING METHOD

(75) Inventors: Takuro NISHIMURA, Minami-ashigara-shi (JP); Takashi SASAKI, Minami-ashigara-shi (JP); Ryutaro KEMMOTSU, Minami-ashigara-shi (JP); Hidekazu YAMAZAKI, Minami-ashigara-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM CORPORATION, Tokyo (JP)

(21) Appl. No.: 12/053,564

(22) Filed: Mar. 22, 2008

(30) Foreign Application Priority Data
Mar. 23, 2007 (JP) 2007-076614

(51) Int. Cl. B29D 7/01

(52) U.S. Cl. 264/212

(57) ABSTRACT

A primary dope containing a polymer, a solvent and an additive is fed to a filtration device in a filtrating unit. The filtration device includes a filter on which a deposit layer of a filtration aid is formed, and impurities in the primary dope are adsorbed to the deposit layer. After the filtration, a residue containing the impurities and the filtration aid on the filter, and the filtration device is filled a cleaning liquid. Then a stirrer in the filtration device is stirred so as to disperse the residue to the cleaning liquid. Thus a slurry liquid is obtained and fed to a separation device. In the separation device, the slurry liquid is fed into a strainer to separate the slurry liquid to the residue and the liquid material. The residue is dried in a drying device and the solvent vapor is recovered.

### BACKGROUND OF THE INVENTION

1. Field of the Invention

The present invention relates to a solution casting method.

2. Description Related to the Prior Art

As optical devices, such as a liquid crystal display device and the like, there are several sorts of polymer film, for example a protective film for a polarizing filter, a wide view film, and the like. The polymer film for the optical use is usually produced by the solution casting method. In the solution casting method, a dope containing a polymer and a solvent is cast onto a running support so as to form a casting film, and then the casting film is peeled from the support and dried to a film. Thus the film is produced without thermal damage. Therefore the solution casting method is the most adequate production method of the polymer film to which the high transparency and the optical properties are required.

By the way, the dope contains impurities, for example dusts which are mixed during the dope preparation, foreign materials which are contents of raw material of the dope but dissolvable to the solvent, and the like. In the case that the dope contains the impurities, they appear as pollution on the support. In this case, the peeling of the casting film from the support becomes difficult. Further, if the produced film contains the impurities, they cause the scattering of the light. Therefore the removal of the impurities is necessary before the casting.

Therefore, in the solution casting method, the filtration of the dope is usually performed with use of a porous filter before the casting. There are several sorts of the filter to be used, for example, a filter paper, a metal filter, a filter fabric and the like. However, in any sort of the filter, the pores through which the dope passes become stopped on time from the start of the casting. Therefore the filtering time sometimes becomes longer. Further, the flow volume through the filter becomes decreased or the filtration pressure becomes increased, which make the filtration efficiency lower. Thus, in the job site of the film production, in the case that it is designate to use the filter paper as the filter, the used filter paper is removed and a new one is set. In the case that it is designate to use the filter fabric and the metal filter as the filter, the cleaning liquid is circulatory fed in a reversal direction to a filtration direction of the dope, in order to make the cleaning of the filter. Therefore although the filter is reused, the productivity becomes lower.

Further, in the case that only the filter is used, it is hard to remove the impurities hardly dissolvable to the solvent. Therefore, in the Japanese Patent Laid-Open Publication No. 2004-107629, a filtration aid is used for removing the undissolvable impurities. The filtration aid is inactive particles or powder, and deposited on the filter randomly in use. Thus in the case that the dope passes through the filter on which the deposition layer is formed as above, the impurities which are undissolvable or dissolvable are adsorbed to the deposition layer, and therefore a dope filtrate of the filtered dope is highly clear. Further, in the case that the filtration aid is used, the stop of the filter is prevented and therefore the productivity becomes larger.

However, in the case of use of the filtration aid as described in the above publication, the impurities deposited on the filter become increasing on time from the start of the filtration, and therefore the filtration efficiency becomes lower. Thus, in the job site of the film production, a filtration device having the filter is opened, and the filter is changed to the new one. However, in this method, the solvent adhered to the filter spatters around, and thus the production site is sometimes polluted. Further, the dope preparation line is stopped to change the filter, and therefore the productivity becomes lower. Therefore, in the above publication, the cleaning liquid is fed in the reverse direction to the filtration direction so as to remove the filtration aid from the filter material. Thus the filtration aid is dispersed in the cleaning liquid, and recovered in a slurry state. However, the concrete description about a method of recovering the filtration aid from the slurry liquid is not made, and therefore a method of efficiently recovering the filtration aid is required without pollution of the filtration device.

### SUMMARY OF THE INVENTION

An object of the present invention is to provide a solution casting method in which the filtration aid and the impurities on or in the filter is recovered in the situation that the filtration device is not opened.

In order to achieve the object and the other object, in a solution casting method of producing a film from a dope containing a polymer and a solvent, the dope is filtrated with use of a first filtration device having a first filter, so as to remove from the dope impurities undissolvable to the solvent. The first filter has a porous layer and a filtration aid deposited to the porous layer. The dope is cast onto a continuously running support, so as to form a casting film. Then the casting film is peeled as the film from the support, and the film is dried. When a filtrating function of the first filtration device becomes lower, a cleaning liquid is fed to the first filtration device in accordance with decreasing a filtrating function of the first filtration device, so as to obtain a slurry liquid of a residue containing the impurities and the filtration aid. The slurry liquid is filtrated with use of a second filtration device having a second filter, so as to separate the residue and the cleaning liquid.

Preferably, a viscosity of the slurry liquid to be fed to the second filtration device is at most 200 mPa·s . A concentration of the slurry liquid is in the range of 0.15 wt. % to 25 wt. %. The slurry liquid in the second filtration device flows vertically in a downward direction.

Preferably, the second filter is a cylindrical metallic mesh filter. Particularly, a mesh number of the mesh filter is in the range of 50 to 490. Especially, the mesh filter satisfies a condition of D<L if a diameter of a bottom face of the cylindrical mesh filter is D and a length is L.

Preferably, the second filter is a filter fabric. Particularly, an air permeability is in the range of 0.3 cc/cm²/sec to 50 cc/cm²/sec.

Preferably, a feeding volume of the slurry liquid to the second filtration device is in the range of 10 L/min to 1500 L/min.

Particularly, the feeding of the slurry liquid to the second filtration device is performed by it's own weight. The feeding of the slurry liquid to the second filtration device is performed by a pump.

Particularly, an averaged thickness of the residue formed in the second filtration device is in the range of 5 mm to 500 mm.

Especially, an air is extracted in a primary situation of feeding the slurry liquid to the second filtration device. More especially, the extraction of the air is performed continuously for at most 5 minutes.

Especially, the slurry liquid is fed back to an upstream side from the second filtration device after the filtration of the second filtration device, when an averaged thickness of the residue is less than 5 mm.

Particularly, the second filter is heated after the removal thereof from the second filtration device, so as to recover the solvent absorbed in a residue layer on the second filter, when an averaged diameter of the residue becomes more than 500 mm. Especially the heating is performed with use of a drying air. More especially, a temperature of the drying air is in the range of 5° C. to 140° C.

Preferably, a number of the first filtration device is at least two, and when the filtration is made with use of one of the plurality of the first filtration devices, the recovering is made with use of another one. Particularly, the first filtration device includes a mesh filter for capturing the filtration aid and an extruding portion for extruding the slurry liquid obtained from the residue on the mesh filter and the cleaning liquid, in accordance with feeding of the cleaning liquid.

According to the present invention, if it is designate to use the filtration device having a tank, the filter on which the filtration aid is deposited, without opening the filtration device for removing the filter, the impurities and the filtration aid on the filter after the filtration is recovered together. Therefore, the high filtration efficiency is kept for the filtration of the dope. Thus the polymer film is produced without decreasing the productivity, and has the high quality.

### BRIEF DESCRIPTION OF THE DRAWINGS

The above objects and advantages of the present invention will become easily understood by one of ordinary skill in the art when the following detailed description would be read in connection with the accompanying drawings:

FIG. 1 is a schematic diagram of a solution casting apparatus according to the present invention;

FIG. 2 is a sectional view of a filtration device in the solution casting apparatus in FIG. 1;

FIG. 3 is a separation device in the solution casting apparatus in FIG. 1;

FIG. 4 is a strainer used in the separation device of FIG. 3; and

FIG. 5 is a schematic diagram of a drying device for drying the strainer of FIG. 4.

### PREFERRED EMBODIMENTS OF THE INVENTION

A solution casting method of the present invention will be explained concretely with description of embodiment thereof. Note that the embodiment in below is an example of the present invention, and it does not restrict the present invention.

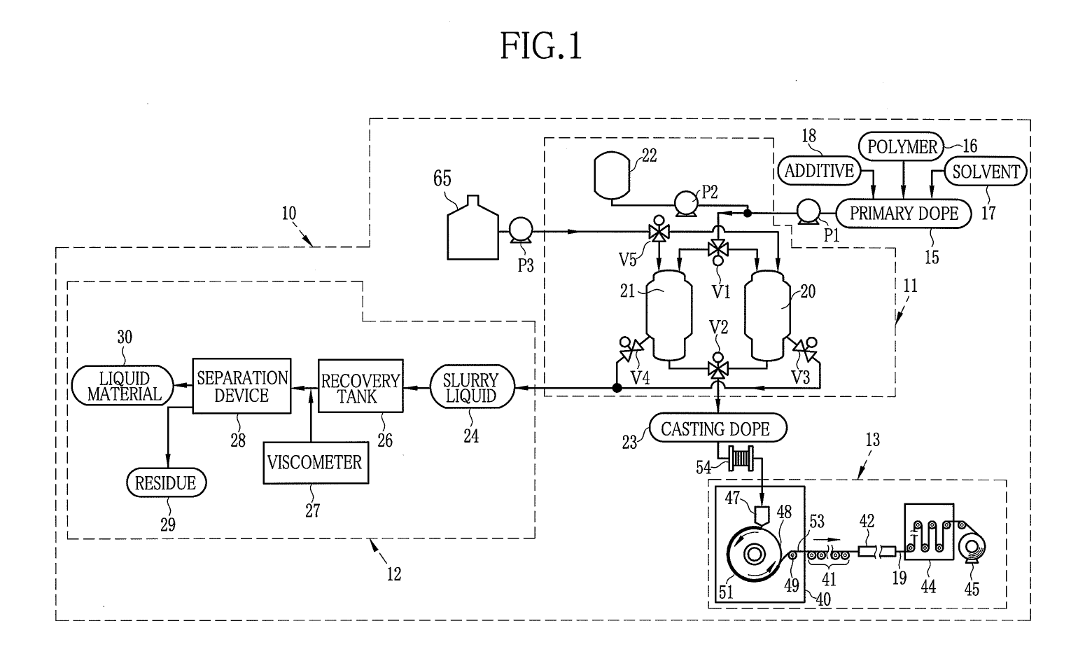

As shown in FIG. 1, a solution casting apparatus 10 includes a filtrating unit 11, a recovering unit 12 and a film producing unit 13.

A primary dope 15 is a material of a film to be produced, and prepared by mixing a polymer 16, a solvent 17, and an additive 18. In the present invention, the polymer 16 is not restricted especially, and may be anything which is adjustable to the solution casting method. However, among them, the polymer 16 is preferably cellulose acylate, in order to produce the film having the high transparency and the excellent optical property. In this case, the film is adequate for the optical film, for example, a protective film for a polarizing filter and an optical compensation film. Especially, when the average of the acetylation degree of the cellulose acylate is in the range of 57.5% to 62.5%, the optical property of the produced film is extremely excellent. The acetylation degree means an amount of acetylic acid bound to the cellulose of a unit weight, and calculated or measured by ASTM: D-817-91 (examination method of cellulose acetate and the like). In this embodiment, particles of the cellulose triacetate is used. Note that in the case that the particle of the polymer is used, the particle diameter of 90 wt. % of the polymer is in the range of 0.1 mm to 4 mm, in view of the compatibility with the solvent.

The solvent 17 is preferably hydrocarbon halides, esters ketones, ethers, alcohols and the like. However, the sorts of the solvent 17 is not restricted especially and chosen adequately in consideration with the solubility of the polymer to be used. The solvent may contain only one solvent component and otherwise a plurality of solvent components. Concretely, the hydrocarbon halide is preferably dichloromethane and the like, the ester is preferably methyl acetate, methyl formate, ethyl acetate, amyl acetate, butyl acetate and the like, the keton is acetone, methylethyl ketone, cyclehexanone, and the like, the ether is preferably dioxane, dioxolane, tetrahydrofuran, diethyether, methyl-t-butylether and the like, and the alcohol is preferably methanol, ethanol and the like.

The additive 18 is chosen in accordance with the required property of the film 19. For example there are plasticizer, UV absorbing agent, peeling improver, fluorochemical surfactant, and the like. The plasticizer is preferably phosphoric acid ester (for example, triphenylphosphate (hereinafter TPP), tricresylphosphate, cresyldiphenylphosphate, octyldiphenylphosphate, biphenyldiphenylphosphate (hereinafter BDP), trioctylphosphate, tributylphosphate, and the like), phthalic acid ester (for example, diethylphthalate, dimethoxyethylphthalate, dimethylphthalate, dioctylphthalate and the like), glycolic acid ester (triacetine, tributyline, butylphthalylbutylglicolate, ethylphthalylethylglicolate, methylphthalylethylglycolate, butylphthalylbutylglycolate and the like) and the like. Among them, the additive 18 is especially preferably TPP for producing the film from the cellulose acylate. Note that other compounds can be used as the plasticizer if they are already known, and the sort is not restricted especially. Further, the UV absorbing agent is preferably, for example, oxybenzophenone type compounds, benzotriazole type compounds, salicylic acid ester type compounds, benzophenone type compounds, cyanoacrylate type compounds, and nickel complex salt type compounds, and especially preferably benzotriazole type compounds and benzophenone type compounds.

The filtrating unit 11 includes filtration devices 20, 21 and a filtration aid tank 22, and make a filtration with use of a filtration aid so as to prepare a casting dope 23. Further, the devices are connected by pipes on which valves V1-V5 are disposed at predetermined positions, and the valves V1-V5 change the pipes in the downstream side if necessary for performing the filtration. Note that the valves and pumps to be disposed in the filtrating unit 11 are not restricted in this embodiment, and may be added or removed if necessary.

In the present invention, there are two sorts of the filtration to be performed. In the first filtration, impurities in the primary dope 15 are removed, and in the second filtration, the filtration of the slurry liquid which is recovered in the filtration device is performed and the residue is recovered. The filtration devices 20, 21 are used for performing the first filtration.

The filtration devices 20, 21 have the same form and are disposed in parallel in the filtering unit 18. And the filtration line can be changed. Therefore, if the filter is stopped in one of the filtration devices and the filtration efficiency becomes lower, the filtration line is changed such that another filtration device may be used. Thus, the work efficiency of the filtration process does not decrease. Note that the number of the filtration device is not restricted especially, and 3 or more of the filtration devices may be disposed in parallel. Further, a plurality of the filtration devices may be disposed serially. In this case, the recovery efficiency of the impurities by the filtration increases dramatically.

The filtration aid tank 22 stored a filtration aid solution feed it at the adequate volume to the filtration devices 20, 21. The filtration aid solution is obtained by dispersing the predetermined filtration aid in the solvent, and used for increasing the capture efficiency of the impurities contained in the primary dope 15. The sort of the filtration aid is not restricted especially, but is preferably particle diatom earth and derivatives of the cellulose type compounds. Further, the solvent of the filtration aid preferably contains at least one of the same solvent components of the solvent in the dope. Note that the filtration aid described in Japanese Patent Laid Open Publication No. 2004-107629 is also applied to the present invention.

For example, in the case that it is designated to use the filtration device 20, the filtration line is changed by the valves V1-V5, and then the filtration aid solution is fed at the adequate volume from the filtration aid tank 22 to the filtration device 20. In the filtration device 20, the liquid material of the filtration aid solution passes through, and the filtration aid is deposited randomly on the filter. Thereafter, the primary dope 15 is fed to the filtration device 20, and then the impurities having the relatively large size are adsorbed when the primary dope 15 passes through the filter. Thus the filtrate having high clearness is obtained and then fed as the casting dope 23 to the film producing unit 13, in which the high quality film is produced without the problems of the impurities.

The recovering unit 12 includes a recovery tank 26, a viscometer 27, and a separation device 28, and recovers the used filtration aid as a slurry liquid 24 from the filtrating unit 11. In the recovering unit 12, the separation device 28 separates the slurry liquid 24 into a solid material as a residue 29 and a liquid material 30. The recovery tank 26 recovers the slurry liquid 24 as a waste liquid after the cleaning the filtration devices 20, 21. The slurry liquid 24 is a dispersion of the residues (containing the filtration aid and impurities) which have remained on the filter of each filtration device 20, 21. In the recovering the residues, the cleaning liquid stored in a cleaning liquid tank 65 is fed to each filtration device 20, 21, and then the dispersion of the residue to the cleaning liquid is made, such that the residue may become a slurry like material. The cleaning liquid preferably contains at least one of the same solvent components of the solvent in the dope, and especially preferably contains non-chloride solvent in view of the environmental protection. Note that the cleaning of the filtration devices 20, 21 will be described later.

The viscometer 27 measures the viscosity of the recovered slurry liquid 24 continuously. On the basis of the measured value, the volume of the cleaning liquid is adjusted such that the viscosity of the slurry liquid may be almost constant, and for example, the viscosity is adjusted to 200 mPa·s or less. Thus the works of separation recovery can be made with keeping the flow volume, and therefore there are no problems on the workability. Note that in the case that the viscosity of the slurry liquid 24 is more than 200 mPa·s, the viscosity I to high, and therefore workability by the separation device 28 may decrease.

The separation device 28 performs the second filtration. The second filtration with use of the separation device 28 is performed in the case that the filtration ability becomes lower. Concretely, in the case that the filtration pressure of the filtration devices 20, 21 becomes larger and the filtration ability becomes lower during the use thereof, the change of feeding rout is made. The change is made when a pressure meter disposed at an exit of each filtration device 20, 21 shows a predetermined value. Further, instead of or in addition to using the pressure meter, the slurry liquid 24 may be recovered from the used filtration devices after the changes, if the filtration is made for a predetermined time.

In the separation device 28, there is a filter having pores through which the slurry liquid 24 passes. Thus the slurry liquid 24 is separated to the residue 29 and the liquid material 30. The filter is preferably a metallic mesh filter of a cylindrical shape. When the slurry liquid 24 passes through the filter, the liquid material 30 of the slurry liquid 24 passes through the pores, and the residue 29 is captured by the pores. Thus the separation efficiency becomes higher than in the methods of the prior art. Further, the filter is also preferably the filter fabric. If it is designate to use the filter fabric, the air permeability thereof is in the range of 0.3 cc/cm²/sec to 50 cc/cm²/sec. Note that the air permeability means a unit volume (cc) of the slurry liquid 24 which passes through 1 cm² of the filter fabric in one second.

In this embodiment, an N₂ gas is used for feeding the slurry liquid 24 from the recovery tank 26 to the separation device 28, while a pressurizing device (not shown) applies the pressure to the N₂ gas. Thus the feeding of the slurry liquid 24 can be made easily. Further, in this method, not only the N₂ gas but also an inactive gas may be used. However, since the inactive gas sometimes dissolves to the slurry liquid 24, it is preferable to adjust the pressure adequately. In the present invention, the feeding method of the slurry liquid 24 from the recovery tank 26 to the separation device 28 may be an aspirating method with use of a pump, a method with use of a weight of the slurry liquid 24, and the combination of these two method. Otherwise the mechanical movement such as the suctioning and the like causes the pressure drop and the rapid pressure release causes the bubble generation. However, the above feeding methods are utilized in the present invention, the pressure drop and the bubble generation are prevented. Further, in this case, it is preferable that the weight concentration of the slurry liquid 24 is in the range of 0.15 wt. % to 25 wt. % in order to keep the smooth flow of the slurry liquid 24. The concentration of the slurry liquid 24 means a weight percentage of the residue 29 contained in the slurry liquid 24.

In the case that the concentration is more than 25 wt. %, it may be difficult to feed the slurry liquid 24, especially to feed it by it's own weight.

The film producing unit 13 includes a casting chamber 40, a transfer area 41, a tenter device 42, a drying chamber 44, a winding device 45. In the film producing unit 13, the film 19 is produced from the casting dope 23. In the casting chamber 40, there are a casting die 47 having an outlet for discharging the casting dope 23, a casting drum 48 used as the support, and a peel roller 49. The casting dope 23 from which the impurities are removed is cast from the casting die 47 onto the casting drum 48 continuously rotating, so as to form a casting film 51. Preferably, a surface temperature of the casting drum 48 is almost constant in the range of −10° C. to 10° C. In this case, the discharged casting dope 23 is cooled on the casting drum 48 immediately, and the gel-like casting film 51 can be formed in a short time. In accordance with the rotation of the casting drum 48, the gelation of the casting film 51 proceeds to have the self supporting property, and then peeled as the wet film 53 from the casting drum 48 with support of the peel roller 49. In the transfer area 41, the wet film 53 is supported with use of a plurality of rollers, and the drying is made during the transfer. In the tenter device 42, both side edge portions of the wet film 53 is kept with use of a holding member such as a pin, and dried. Then the wet film 53 is fed out as the film 19 from the tenter device 42, and wound around the winding device 45.

In this embodiment, the filtration device 54 having the filter is disposed in an upstream side from the casting die 47 so as to make the filtration of the casting dope 23 before the casting. Thus the impurities in the casting dope 23 are removed. The filter in the filtration device 54 is preferably the metallic filter. But the filter is not restricted in it, and may be a filter paper. The pores of the filter preferably has an averaged porous diameter of at most 100 μm in order to remove the impurities. If the averaged diameter is too small, it takes long time to make the filtration, and therefore the filtration efficiency becomes lower. Otherwise, if the averaged porous diameter is too large, it is difficult to remove the microscopic impurities. The filter is produced so as to be the adequate structure in consideration with the productivity and the like.

Then the method of cleaning the filtration device after the use will be described now.

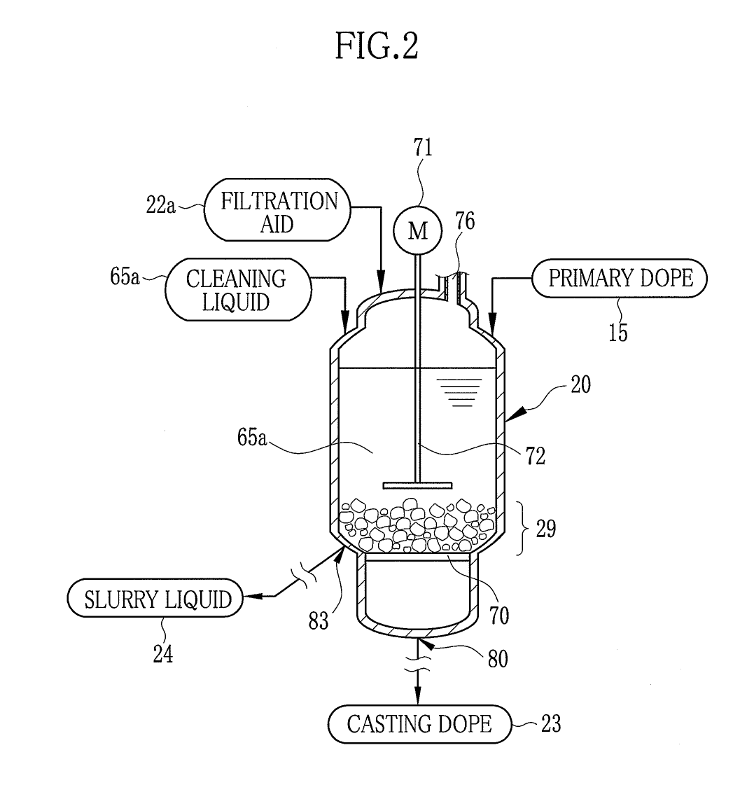

As shown in FIG. 2, the filtration device 20 includes a filter 70 and a stirrer which is rotated by a motor 71. On a top of the filtration device 20, there is a pipe 76 through which an inner air is destructed. Further, there are a pipe for feeding a cleaning liquid 65a, a pipe for feeding the primary dope 15 and a pipe for feeding the filtration aid 22a in order to prevent the complexity of the figure. However, these pipes are not shown in order to prevent the complexity of the figure. Furthermore, on a bottom and a periphery of the filtration device 20, there are a first outlet 80 for extracting the casting dope 23 and a second outlet 83 for extracting the slurry liquid 24. Each first and second outlet 80, 83 has a valve and is connected to a pipe (not shown) for feeding the casting dope 23. Note that the filter 70 is also used for removing the impurities and as the support on which the filtration aid is deposited.

If a predetermined time passes after the start of the filtration, or if a filtration pressure increases to a predetermined value, a residue on the filter 70 is recovered. On the recovering, at first the first outlet 80 is closed, and a predetermined amount of the cleaning liquid 65a is supplied into the filtration device 20 through the pipe for feeding the cleaning liquid 65a, and thereafter the motor 71 is driven to rotate a stirrer 72. Thus the residues 29 deposited on the filter is stirred and dispersed in the cleaning liquid 65a, such that the slurry liquid 24 is obtained. The slurry liquid 24 is extracted through the second outlet 83, and fed to a recovery unit (not shown). Thus the residue 29 is recovered efficiently without remaining on the filter 70, and the filter 70 is cleaning without opening and closing the filtration device 20. Therefore, the spattering of the solvent in outside and the pollution are prevented.

Further, when the filtration of the primary dope 15 is made with use of the filtration device 20, or when the cleaning is made with use of the cleaning liquid 65a, the air extraction is preferably performed through the pipe 76. The reason for it is that the air intrudes into the filtration devices 20, 21 when the change of the filtration devices 20, 21 is made. Note that the extraction portion for extracting the slurry liquid is constructed of an extraction pipe having the extraction valve which is provided for the filtration device 20, and a stirring member such as the stirrer 72 for stirring the residue 29. However, the stirring member is not restricted the stirrer 72, and may be a cylindrical mesh filter which is to be rotated by a motor. Thus the residue is stirred in effect of the centrifugal force.

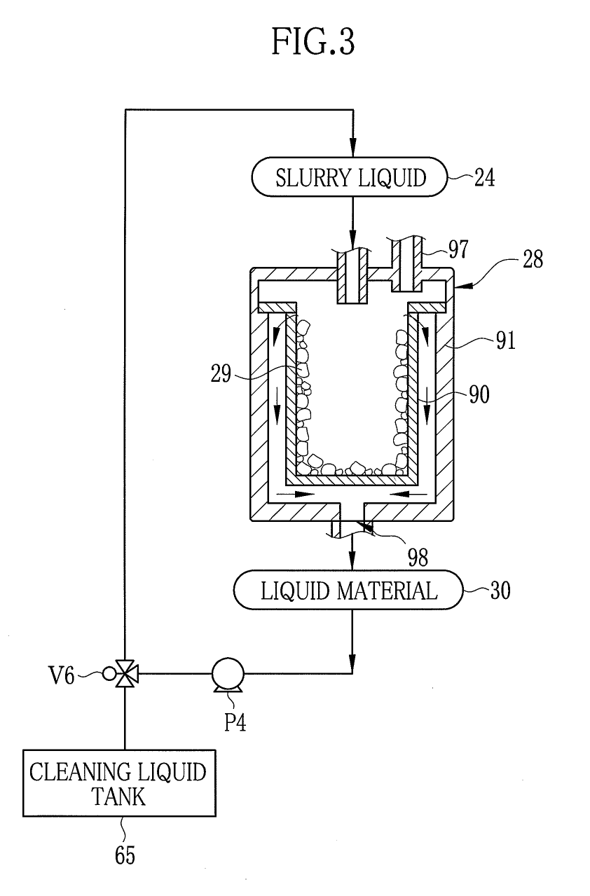

The slurry liquid 24 is fed through the recovery tank 26 to the separation device 28 (See, FIG. 1). As shown in FIG. 3, the separation device 28 includes a strainer 90 and a tank 91. The strainer 90 is arranged vertically in the tank 91. The slurry liquid 24 is fed from the upper side of the separation, so as to flow to the lower side vertically. The liquid material passes through the strainer 90, and the residue 29 remains on an inner wall of the strainer 90. Thus the filtration aid contained in the residue 29 can be easily removed from the slurry liquid 24 since the filtration aid has the high sedimentation property. The separation device 28 may have a structure that the residue may be remain on an outer wall of the strainer 90.

In the separation device 28, the tank 91 is combined with a pipe 97 for extracting the inner air from the tank 91. The extraction of the inner air is performed in an initial period from beginning the supply of the slurry liquid 24. Thus the inner air does not accumulate and therefore the residue 29 forms on the strainer 90 a layer having a uniform thickness. However, if the time of the extraction of the air becomes long, the sedimentation of the filtration aid easily occurs, and the layer of the residue 29 cannot have the uniform thickness. Therefore the time for the extract of the air is at most 5 minutes. Note that the initial state means a period of 5 minutes from the beginning of the supply of the slurry liquid, and the period of the extraction of the inner air is included in the initial period.

The thickness of the residue on the strainer 90 is preferably in the range of the 5 mm to 50 mm, and is measured after the remove the strainer 90 actually, or estimated from the flow volume and the feeding time of the slurry liquid 24. If the thickness is more than 500 mm, it is difficult to keep the flow volume of the slurry liquid 24 constant, and the pressure loss becomes large, and since the inner pressure becomes too high, the separation device 28 may be broken in the point of the point of the durability. If the residue 29 is less than 5 mm, it is necessary to make the filtration size large, which needs the large size of the device.

Further, the separation device 28 has a pressure meter for measuring an inner pressure during the feed of the slurry liquid 24, and the fluctuation of the inner pressure can be known by the measurement. In accordance with the filtration resistance, the flow rate of the slurry liquid 24 is adjusted in the range of 10 L to 1500 L for a total filtration size. Thus the filtration can be made without making the separation time longer. If the flow rate is more than 1500 L, the big tank is necessary, which causes the increase of the cost and makes difficult to keep the installation space. Further, if the flow rate is less than 10 L, it takes long time for the separation.

The liquid material 30 separated from the residue 29 in the slurry liquid 24 is extracted from the separation device 28 through an outlet 98 formed on a bottom of the tank 91. Then a valve V6 is switched such that the liquid material may be circulatory fed to the separation device 28 by a pump P4. Since the efficiency of the capturing the residue 29 by the strainer 90 is low just after the start of the separation, the liquid material to be recovered is suspended. If a predetermined time passes, the thickness of the residue 29 on the strainer 90 becomes 5 mm or more, and then the efficiency of the capture of the residue 29 is higher. After the separation, the filtrate is sent to the cleaning liquid tank 65, and reused for cleaning of the filtration device or as the solvent for the dope preparation.

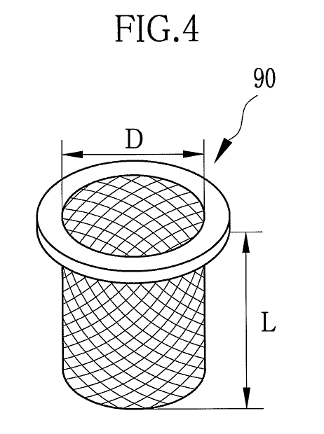

The mesh number is preferably in the range of 50 to 490, so as to make the separation effectively. The mesh number is determined in accordance with the diameter of metallic wire used for forming the strainer 90, and a number of meshes in one cm². Further, in FIG. 4 the strainer 90 preferably satisfies a condition of D<L if D is the diameter of the cylindrical shape of the strainer 90 and L is a length of the strainer 90. In this case, the filtration size is can be enough for making the filtration effectively, and therefore the stop of the meshes is reduced to keep the high filtration effectives. Otherwise, in the condition of D≧L, the filtration size is not enough, and therefore the stop of the meshes easily occurs. The filtration size is a size of an area through which the slurry liquid passes.

In order to separate the residue 29 from the slurry liquid 24 effectively, it is Preferable that the strainer 90 is a plain dutch weave or a twilled dutch weave. Further, in the metallic net produced by weaving the metallic wire, a punching metal is used as a strengthening agent. In order to reduce the filtration resistance which occurs by the strengthening agent, the aperture rate is preferably 30% or more.

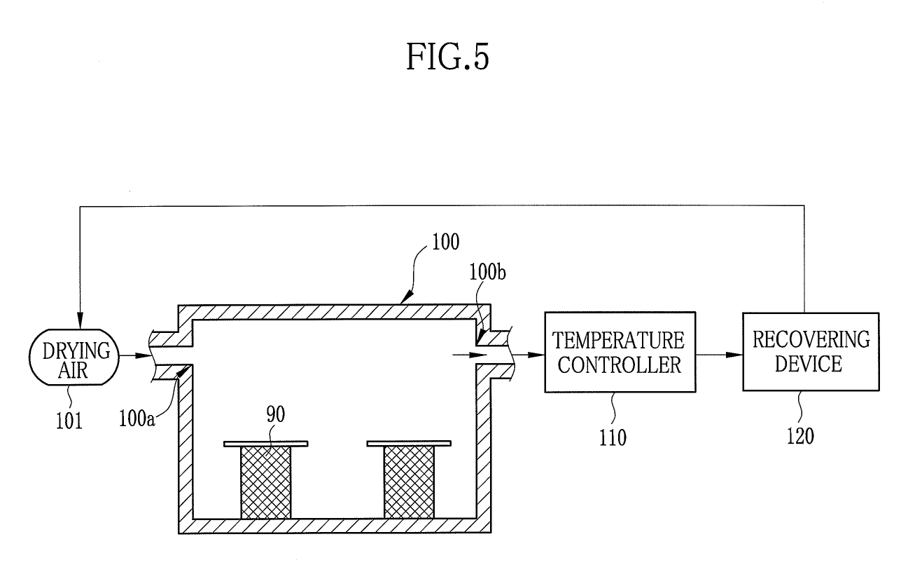

The used strainer 90 on which the residue 29 is deposited is removed from the separation device 28. Then as shown in FIG. 5, the strainer 90 is dried in a drying device 100. The drying device 100 has an inlet 100a for supplying a drying air 101 whose temperature is controlled in a predetermined range, and an outlet 100b for extracting the drying air 101 from the drying device 100. In the drying device 100, the strainer 90 is disposed with an upper opening thereof directed upward. Then the drying air 101 is fed into the drying device 100 through the inlet 100a. The temperature of the drying air is preferably in the range of 5° C. to 140° C. Thus the residue 29 is dried such that the solvent components in the residue may be evaporated. In the case that the temperature is more than 140° C., the strainer 90 may be sometimes damaged thermally. In the case that the temperature is less than 5° C., the drying time becomes longer and the workability may become lower. Note that the device and the method of the drying are not restricted especially, so far as the strainer 90 is heated such that the temperature thereof may increase to a predetermined range. For example, a steam is blown to the strainer so as to heat it directly. In this case, the drying can be made effectively in a short time.

In the drying device 100, the drying air 101 contains the solvent vapor, and therefore recovered by a recovering device 110. In the recovering device 110, the solvent vapor is removed from the drying air 101. Then the drying air 101 is heated by a temperature controller 120, and supplied into the drying device 100. Since the drying device 100 is tightly closed as described above, the recovery of the solvent vapor is performed without leaking the solvent vapor. Therefore, the pollution of the job site is prevented and the environmental load is reduced.

Japanese Patent Laid-Open Publication No. 2005-104148 describes from [0617] to [0889] in detail about the structures of the casting die, the decompression chamber, the support and the like, and further about the co-casting, the peeling, the stretching, the drying conditions in each process, the handling method, the curling, the winding method after the correction of planarity, the solvent recovering method, the film recovering method. The descriptions thereof can be applied to the present invention.

According to the film to be obtained in the present invention, The transparency and the retardation are high, and the humidity dependency is low. Therefore, the film is preferably used for a birefringent film. The concrete method of using the cellulose ester film of the present invention is described from [1088] to [1265] in Japanese Patent Laid Open Publication No. 2005-104148. The publication discloses the liquid crystal displays of TN type, STN type, VA type, OCB type, reflective type, and other types in detail. The description may be applied to the present invention.

In followings, the concrete explanation of the present invention will be made by showing examples and comparisons of the present invention. Note that the present invention is not restricted the examples and the comparisons.

### EXAMPLE 1

The primary dope 15 was prepared by mixing the following raw materials. In this example, the solvent 17 was a mixture solvent of dichloromethane, methanol, and 1-butanol.

| | | |
|---|---|---|
| Cellulose Triacetate | 100 | pts. wt. |
| Dichloromethane (first component of solvent) | 320 | pts. wt. |
| Methanol (second component of solvent) | 83 | pts. wt. |
| 1-butanol (third component of solvent) | 3 | pts. wt. |
| Plasticizer A (triphenylphosphate) | 7.6 | pts. wt. |
| Plasticizer B (diphenylphosphate) | 3.8 | pts. wt. |
| UV agent A | 0.7 | pts. wt. |
| UV agent B | 0.3 | pts. wt. |
| Mixture of citric acid esters | 0.006 | pts. wt. |
| Particles | 0.05 | pts. wt. |

The above cellulose triacetate was powder. According thereto, degree of substitution was 2.84, viscosity-average degree of polymerization was 306, the water content was 0.2 wt. %, the viscosity of 6 wt. % dichloromethane solution was 315 mPa·s, the averaged particle diameter was 1.5, the standard deviation was 0.5. The Plasticizer A was triphenyl phosphate, and the plasticizer B was diphenyl phosphate. The UV agent A was (2(2′-hydroxy-3′,5′-di-tert-butylphenyl)-5-chlorobenzotriazol), and the UV agent B was (2(2′-hydroxy-3′,5′-di-tert-amylphenyl)benzotriazol). The mixture of citric acid esters is a mixture of mono-, di- and tri-ethylesters of thecitric acid. The particles are silicon dioxide, whose averate diameter was 15 nm and the Mohs Hardness was about 7. Further, while the primary dope 15 is prepared, N—N-di-toluyl-N—P-methoxyphenyl-1,3,5triadine-2,4,6-triamine) is added as a retardation controller, such that the weight percentage thereof in the obtained film might be 4.0 wt. %.

Then in the solution casting apparatus 10, the filtration of the primary dope 15 was made with use of the filtration device 20 in the filtrating unit 11. A diatom earth was used as the filtration aid, and deposited on the filter in the filtration device previously before the casting.

After the filtration with use of the filtration device 20, the residue 29 remaining on the filter in the filtration device 20 is recovered. During the cleaning, the cleaning liquid is supplied into from the cleaning liquid tank 65 to the filtration device 20 by driving the pump P3. Then as shown in FIG. 2, the cleaning liquid 65a is stirred by the stirrer 65a provided in the filtration device 20, such that the residue 29 on the filter 70 was dispersed to the cleaning liquid 65a. When the residue was recovered, the air was extracted through the pipe 76, and the slurry liquid 24 was fed out through the second outlet 83.

Thereafter, the slurry liquid 24 was fed through the recovery tank 26 to the separation device 28, and separated into the residue 29 of the solid material and the liquid material 30. The feeding method of the slurry liquid 24 was a method of pneumatic transportation method with use of the N₂ gas. The pressure of this method was 0.1 MPa. In the separation device 28, the strainer 90 was made of metal and was a cylindrical shape, whose length was 800 mm and the opening diameter φ was 400 mm. The net of the strainer was plain dutch weave, and the mesh number was 100. Note that the total filtration area of the strainer was 1 m², and the flow rate through the total filtration area was 160 L/min.

The separation device 29 is supplied with the slurry liquid 24 whose viscosity was 10 mPa and in which the content of the residue was 3 wt. %. The slurry liquid 24 was fed from the upper side of the strainer into the lower side vertically, and the liquid material 30 was extracted through the outlet 98 of the tank 91 from the separation device 28. After the recovery, the thickness of the layer of the residue 29 on the strainer was 100 mm. In the primary situation of the separation, a small amount of the residue 29 was leaked from the strainer, and therefore the filtrate was fed back to the recovery tank. Thereafter the clearness of the filtrate was estimated, and then removed as the recovered filtrate. Further, in the primary situation of the recovery, the extraction of the air from the separation device 28 was performed for 1.5 minutes. Then after the separation, the clearness of the filtrate was observed with eyes, and the filtrate was extremely clear.

After the slurry liquid 24 into the residue 29 and the liquid material 30 was separated completely, the liquid material remaining in the strainer was blasted off. Then the strainer was recovered, and as shown in FIG. 5, the drying air at 40° C. was supplied with use of the drying device 100, so as to dry the strainer. As a result, after 48 hour from the start of the drying, the content of the liquid material in the residue 29 was at most 0.2 wt. %, and therefore the drying was made enough. The content of the liquid material can be calculated from the following formula, if the weight of the residue was x before the drying and y after the drying: [(x−y)/y]×100.

### EXAMPLE 2

In Example 2, the viscosity of the slurry liquid was 200 mPa·s. Other conditions were the same as Example 1, and the separation of the slurry liquid 24 was performed. As a result, the flow rate through the total filtration area was continuously 12 L/min, and the separation was performed in a predetermined time.

### EXAMPLE 3

In Example 3, the weight percentage of the slurry liquid was 0.15 wt. %. Other conditions were the same as Example 1, and the separation of the slurry liquid 24 was performed. As a result, it took 5 times longer to feeding the recovered filtrate to the recovery tank than Example 1. However there were no problems of productivity.

### EXAMPLE 4

In Example 4, the weight percentage of the slurry liquid was 25 wt. %. Other conditions were the same as Example 1, and the separation of the slurry liquid 24 was performed. As a result, the flow rate through the total filtration area was continuously 12 L/min, and the separation was performed in a predetermined time.

### EXAMPLE 5

In Example 5, the mesh number of a metal net constructing the strainer was 50. Other conditions were the same as Example 1, and the separation of the slurry liquid 24 was performed. As a result, the clearness of the filtrate becomes lower, and therefore it took 3 times longer to feeding the recovered filtrate to the recovery tank than Example 1. However there were no problems of productivity.

### EXAMPLE 6

In Example 6, the mesh number of a metal net constructing the strainer was 490. Other conditions were the same as Example 1, and the separation of the slurry liquid 24 was performed. As a result, the flow rate through the total filtration area was continuously 15 L/min, and the separation was performed without problems of the productivity.

### EXAMPLE 7

In Example 7, instead of the strainer used in the Example 1, a filtration cloth was used. According to the filtration cloth, the diameter was 400 mm, and the length in a depth direction was 800 mm. The air permeability of the filter fabric was 0.3 cc/cm²/sec. Other conditions were the same as Example 1, and the separation of the slurry liquid 24 was performed. As a result, the flow rate through the total filtration area was continuously 12 L/min, and the obtained filtrate had high degree of clarification.

### EXAMPLE 8

In Example 8, instead of the strainer used in Example 1, the strainer whose opening diameter was 400 mm and length was 800 mm was used. Other conditions were the same as Example 1. Note that the air permeability of the filter fabric was 25 cc/cm²/sec. As a result, while the slurry liquid 24 was fed through the filter fabric, the flow rate was at least 140 L/min. Further, after the separation, the filtrate having the high clearness was obtained.

### EXAMPLE 9

In Example 9, instead of the strainer used in Example 1, the strainer whose opening diameter was 400 mm and length was 800 mm was used. Other conditions were the same as Example 1. Note that the air permeability of the filter fabric was 50 cc/cm²/sec. As a result, while the slurry liquid 24 was fed through the filter fabric, the flow rate was at least 190 L/min. Further, after the separation, the filtrate having the high clearness was obtained.

### EXAMPLE 10

In Example 10, while the slurry liquid 24 was fed to the second filtration device, the flow rate of the slurry liquid 24 was 1500 L/min, and the feeding pressure was 0.8 MPa. Other conditions were the same as Example 1. As a result, after the separation, the filtrate having the high clearness was obtained.

### EXAMPLE 11

In Example 11, while the slurry liquid 24 was fed to the second filtration device, the flow rate of the slurry liquid 24 was 10 L/min, and the feeding pressure was 0.006 MPa. Other conditions were the same as Example 1. As a result, the separation was made in a predetermined time.

### EXAMPLE 12

In Example 12, the recovery tank 26 was disposed 30 m apart from the separation device 28 in the upper side. Other conditions were the same as Example 1. As a result, while the slurry liquid 24 was fed to the separation device 28, the flow rate of the slurry liquid was at least 50 L/min. Further, after the separation, the filtrate having the high clearness was obtained.

### EXAMPLE 13

In Example 13, the supplying method from the recovery tank 26 to the separation device 28 was the aspirating method with use of the pump. Other conditions were the same as Example 1. As a result, while the slurry liquid 24 was fed to the separation device 28, the flow rate of the slurry liquid was at least 50 L/min. Further, after the separation, the filtrate having the high clearness was obtained.

### EXAMPLE 14

In Example 14, the averaged thickness of the residue in the second filtration device was 5 mm. Other conditions were the same as Example 1. As a result, after the separation, the filtrate having the high clearness was obtained.

### EXAMPLE 15

In Example 15, the extraction of the air in the separation device 28 was made for 5 minutes continuously. Other conditions were the same as Example 1. As a result, according to the pillar-shaped strainer, a thickness of the residue was 50 mm on the side face, and 490 mm on the bottom. Further, after the separation, the filtrate having the high clearness was obtained.

### EXAMPLE 16

In Example 16, the drying temperature for drying the strainer was 140° C. Other conditions were the same as Example 1. As a result the strainer was not rusted.

### EXAMPLE 17

In Example 17, the drying temperature for drying the strainer was 5° C. Other conditions were the same as Example 1. As a result it took 7 days for drying.

### EXAMPLE 18

In Example 18, when the drying of the strainer is performed, the strainer is directly heated. Other conditions were the same as Example 1. As a result, the content of the liquid material in the residue was smaller 36 hours after the start of the drying.

[Comparison 1]

In Comparison 1, the viscosity of the slurry liquid 24 was 210 Pa·s. Other conditions were the same as Example 1. As a result, while the slurry liquid 24 was fed to the separation device 28, the flow volume of the slurry liquid was only 10 L/min.

[Comparison 2]

In Comparison 2, the weight percentage of the slurry liquid 24 was 0.10 wt. %. Other conditions were the same as Example 1. As a result, The residue 29 didn't deposit on the strainer adequately, and the filtrate didn't have a predetermined degree of the clarification

[Comparison 3]

In Comparison 3, the content of the residue in the slurry liquid was 27 wt. %. Other conditions were the same as Example 1. As a result, the feeding of the slurry liquid 24 from the recovery tank 26 into the separation device 28 could not be made by applying the pressure with use of the N₂ gas.

[Comparison 4]

In Comparison 4, the opening of the strainer 90 was disposed in a lower side from the strainer and in a lower part of the separation device 28. The slurry liquid was fed through the lower part of the separation device 28 so as to flow upwardly in the vertical direction. Other conditions were the same as Example 1. As a result, the slurry liquid 24 founders in the separation device 28 during the feeding, and it took long time to recover in the strainer. The separation could not be made effectively.

[Comparison 5]

In comparison 4, the mesh number of the metallic strainer was 40. Other conditions were the same as Example 1. As a result, the leaking of the slurry liquid 24 was terrible, and the filtrate was not clear.

[Comparison 6]

In comparison 6 the mesh number of the metallic strainer was 500. Other conditions were the same as Example 1. As a result, since the mesh was too small, the residence for separating the slurry liquid became large, and the flow volume of the slurry liquid 24 was only 8 L/min.

[Comparison 7]

In Comparison 7, the strainer whose opening diameter φ was 1100 mm and length was 200 mm (filtration area was 1.6 m²) was used. Other conditions were the same as Example 1. As a result, the thickness of the residue 29 was 1000 mm after the recovery, and the flow volume of the slurry liquid was 8 L/min during the separation.

[Comparison 8]

In Comparison 8, the filtrate obtained in the primary situation from the start of the separation was recovered, and the primary circulation of the feeding was not made. Other conditions were the same as Example 1. As a result, the obtained filtrate contained a lot of residue 29, and the filtration had to be made again.

[Comparison 9]

In Comparison 9, while the slurry liquid 24 was fed to the second filtration device, the flow rate of the slurry liquid 24 was 1700 L/min, and the feeding pressure was 0.9 MPa. Other conditions were the same as Example 1. As a result, the filtrate didn't have a predetermined degree of the clarification

[Comparison 10]

In Comparison 10, while the slurry liquid 24 was fed to the second filtration device, the flow rate of the slurry liquid 24 was 8 L/min, and the feeding pressure was 0.005 MPa. Other conditions were the same as Example 1. As a result, it took a long tome to completely perform the separation, and therefore the separation was not completed in a predetermined time. Thus there was a problem of the productivity.

[Comparison 11]

In Comparison 11, the extraction of the air in the separation device 28 was not made. Other conditions were the same as Example 1. As a result, the upper side in the strainer was not filled with the slurry liquid 24, and the gas-liquid interface was formed. The residue 29 was mixed with the filtrate continuously, and the reason for it is probably that the fluctuation occurred on the liquid surface. Therefore the filtrate was not clear.

[Comparison 12]

In Comparison 12, while the slurry liquid 24 was fed from the recovery tank 26 to the separation device 28, the pressure of the N² gas was 0.01 MPa. Further, the extraction of the air in the separation device 28 was made for 7 minutes continuously. Other conditions were the same as Example 1. As a result, the residue 29 foundered during the extraction, and deposited in the lower side of the strainer. Thus the thickness of the deposited residue 29 was 600 mm, and the thickness unevenness occurred. Therefore, it took long time to dry the portion of the large thickness of the deposited residue 29. As a result, it took 1 week to dry it enough.

[Comparison 13]

In comparison 13, the temperature of the drying air was 4° C., and other conditions were the same as Example 1. As a result, it took 1.5 weeks to dry the strainer completely.

[Comparison 14]

In comparison 14, the temperature of the drying air was 145° C., and other conditions were the same as Example 1. As a result, it took 0.5 hours to dry the strainer completely. However, the deterioration of the strainer was observed.

[Comparison 15]

In Comparison 15, the air permeability of the filter fabric was 0.25 cc/cm²/sec, and other conditions were the same as Example 2. As a result, the resistance became large in the process of the separation, and the flow volume of the slurry liquid 24 was 7 L/min.

[Comparison 16]

In Comparison 16, the air permeability of the filter fabric was 60 cc/cm²/sec, and other conditions were the same as Example 2. As a result, the leaking of the slurry liquid was terrible in the process of the separation, and the filtrate was not clear.

Further, in Example 1, the casting dope 23 was used for producing the film 19 in the film producing unit 13 of FIG. 1. Thus the residue was removed from the casting dope 23 effectively, the casting drum 48 didn't have any pollution, and the film 19 was produced at high speed so to have a high quality without the impurities.

As described above, in the present invention, the residue remaining on the filter after the filtration is dispersed to the cleaning liquid and recovered as the waste liquid of a slurry state effectively. Further, if only the simple separation device is used, the waste liquid is separated into the residue and the liquid material effectively, and thereafter the solid material is recovered and the filter used for the separation is reused after the drying thereof. Thus the solution casting apparatus doesn't become larger and more complicating. Further there is a merit in the production cost.

Various changes and modifications are possible in the present invention and may be understood to be within the present invention.

What is claimed is:

1. A solution casting method of producing a film from a dope containing a polymer and a solvent, comprising:
filtrating said dope with use of a first filtration device having a first filter, so as to remove from said dope impurities undissolvable to said solvent, said first filter having a porous layer and a filtration aid deposited to said porous layer;
casting said dope onto a continuously running support after the removal, so as to form a casting film;
peeling said casting film as said film from said support;
drying said film;
feeding a cleaning liquid to said first filtration device in accordance with decreasing a filtrating function of said first filtration device so as to obtain a slurry liquid of a residue containing said impurities and said filtration aid, when a filtrating function of said first filtration device becomes lower; and
filtrating said slurry liquid with use of a second filtration device having a second filter, so as to separate said residue and said cleaning liquid.

2. A solution casting method as described in claim 1, wherein a viscosity of said slurry liquid to be fed to said second filtration device is at most 200 mPa·s.

3. A solution casting method as described in claim 1, wherein a concentration of said slurry liquid is in the range of 0.15 wt. % to 25 wt. %.

4. A solution casting method as described in claim 1, wherein said slurry liquid in said second filtration device flows vertically in a downward direction.

5. A solution casting method as described in claim 1, wherein said second filter is a cylindrical metallic mesh filter.

6. A solution casting method as described in claim 5, wherein a mesh number of said mesh filter is in the range of 50 to 490.

7. A solution casting method as described in claim 6, wherein said mesh filter satisfies a condition of D<L if a diameter of a bottom face of said cylindrical mesh filter is D and a length is L.

8. A solution casting method as described in claim 1, wherein said second filter is a filter fabric.

9. A solution casting method as described in claim 8, wherein an air permeability is in the range of 0.3 cc/cm²/sec to 50 cc/cm²/sec.

10. A solution casting method as described in claim 1, wherein a feeding volume of said slurry liquid to said second filtration device is in the range of 10 L/min to 1500 L/min.

11. A solution casting method as described in claim 10, wherein the feeding of said slurry liquid to said second filtration device is performed by it's own weight.

12. A solution casting method as described in claim 10, wherein the feeding of said slurry liquid to said second filtration device is performed by pressurizing with use of a gas.

13. A solution casting method as described in claim 10, wherein the feeding of said slurry liquid to said second filtration device is performed by a pump.

14. A solution casting method as described in claim 10, wherein an averaged thickness of said residue formed in said second filtration device is in the range of 5 mm to 500 mm.

15. A solution casting method as described in claim 14, further comprising a step of:
extracting an air in a primary situation of feeding said slurry liquid to said second filtration device.

16. A solution casting method as described in claim 15, wherein the extraction of said air is performed continuously for at most 5 minutes.

17. A solution casting method as described in claim 14, further comprising:
feeding said slurry liquid back to an upstream side from said second filtration device after the filtration of said second filtration device, when an averaged thickness of said residue is less than 5 mm.

18. A solution casting method as described in claim 14, further comprising a step of:
heating said second filter after removing it from said second filtration device so as to recover said solvent absorbed in a residue layer on said second filter, when an averaged diameter of said residue becomes more than 500 mm.

19. A solution casting method as described in claim 18, wherein said heating is performed with use of a drying air.

20. A solution casting method as described in claim 19, wherein a temperature of said drying air is in the range of 5° C. to 140° C.

21. A solution casting method as described in claim 1, wherein a number of said first filtration device is at least two, and when the filtration is made with use of one of the plurality of said first filtration devices, the recovering is made with use of another one.

22. A solution casting method as described in claim 21, wherein said first filtration device includes a mesh filter for capturing said filtration aid and an extruding portion for extruding said slurry liquid obtained from said residue on said mesh filter and said cleaning liquid, in accordance with feeding of said cleaning liquid.
